(19) United States
(12) Patent Application Publication
(10) Pub. No.: US 2025/0252629 A1
(43) Pub. Date: Aug. 7, 2025

(54) STYLE IMAGE GENERATION METHOD AND APPARATUS, DEVICE AND MEDIUM

(71) Applicant: Beijing Zitiao Network Technology Co., Ltd., Beijing (CN)

(72) Inventor: Mingda SHI, Beijing (CN)

(21) Appl. No.: 18/853,342

(22) PCT Filed: Mar. 24, 2023
(86) PCT No.: PCT/CN2023/083653

§ 371 Date: Oct. 1, 2024

(30) Foreign Application Priority Data
Apr. 1, 2022 (CN) 202210347666.9

(51) Int. Cl. G06T 11/60

(52) U.S. Cl. CPC G06T 11/60

(57) ABSTRACT

The embodiments of the present disclosure relate to an style image generation method and apparatus, a device and a medium, wherein the method comprises: acquiring an image to be processed comprising a face image region, acquiring a target face stylization algorithm from preset face stylization algorithms, and performing a stylization processing on the face image region based on the target face stylization algorithm to obtain a face stylization image; performing a processing based on the face stylization image and the image to be processed to obtain a target image; and switching from displaying the image to be processed to displaying the target image according to a preset rendering parameter.

### CROSS-REFERENCE TO RELATED APPLICATIONS

This application is based on and claims the benefit of priority to the Chinese patent application No. 202210347666.9 filed on Apr. 1, 2022, which is hereby incorporated by reference in its entirety into the present application.

### TECHNICAL FIELD

The present disclosure relates to the field of image processing, in particular to a style image generation method and apparatus, a device and a medium.

### BACKGROUND

With the rapid development of Internet technology and smart terminals, personalized needs and use experiences of users are met by beautifying and stylizing images.

In the related technology, through a deep learning network and other means, a face image is directly subjected to a stylization processing and displayed.

### SUMMARY

According to some embodiments of the present disclosure, a style image generation method is provided, comprising:
acquiring an image to be processed comprising a face image region;
randomly acquiring a target face stylization algorithm from preset face stylization algorithms, and performing a stylization processing on the face image region based on the target face stylization algorithm to obtain a face stylization image;
performing a processing based on the face stylization image and the image to be processed to obtain a target image; and
switching from displaying the image to be processed to displaying the target image according to a preset rendering parameter.

According to some embodiments of that present disclosure, a style image generation apparatus is also provided, comprising:
an image acquiring module configured to acquire an image to be processed comprising a face image region;
an algorithm acquiring module configured to randomly acquire a target face stylization algorithm from preset face stylization algorithms;
a stylization processing module configured to perform a stylization processing on the face image region based on the target face stylization algorithm to obtain a face stylization image;
a processing module configured to perform a processing based on the face stylization image and the image to be processed to obtain a target image; and
a display switching module configured to switch from displaying the image to be processed to displaying the target image according to a preset rendering parameter.

According to some embodiments of the present disclosure, an electronic device is also provided, wherein the electronic device comprises: a processor; a memory configured to store executable instructions of the processor, wherein the processor is configured to read the executable instructions from the memory and executing the executable instructions to implement the style image generation method as provided in any embodiment of the present disclosure.

According to some embodiments of the present disclosure, a computer-readable storage medium is also provided, wherein the storage medium stores a computer program, which when executed by a processor causes the processor to implement the style image generation method as provided in any embodiment of the present disclosure.

According to some embodiments of the present disclosure, a computer program is also provided, comprising: instructions, which when executed by a processor, cause the processor to implement the style image generation method as provided in any embodiment of the present disclosure.

### BRIEF DESCRIPTION OF THE DRAWINGS

By combining the accompanying drawings and referring to the following Detailed Description, the above and other features, advantages, and aspects of each embodiment of the present disclosure will become more apparent. Throughout the accompanying drawings, the same or similar drawing reference signs indicate the same or similar elements. It should be understood that the accompanying drawings are illustrative, and elements may not necessarily be drawn to scale relative to the originals.

FIG. 1 is a flowchart of a style image generation method provided in some embodiments of the present disclosure.

FIG. 2 is a flowchart of a style image generation method provided in some other embodiments of the present disclosure.

FIG. 3a is a schematic diagram of an image display provided in some embodiments of the present disclosure.

FIG. 3b is a schematic diagram of an image to be processed provided in some embodiments of the present disclosure.

FIG. 4a is a schematic diagram of a style image provided in some embodiments of the present disclosure.

FIG. 4b is a schematic diagram of a style image provided in some other embodiments of the present disclosure.

FIG. 5a is a schematic diagram of switching and displaying an image provided in some embodiments of the present disclosure.

FIG. 5b is a schematic diagram of switching and displaying an image provided in some other embodiments of the present disclosure.

FIG. 6 is a schematic diagram of structure of a style image generation apparatus provided in some embodiments of the present disclosure.

FIG. 7 is a schematic diagram of structure of a piece of electronic device provided in some embodiments of the present disclosure.

### DETAILED DESCRIPTION

A more detailed description of the embodiments of the present disclosure will be provided below with reference to the accompanying drawings. Although certain embodiments of the present disclosure are shown in the accompanying drawings, it should be understood that the present disclosure can be realized in various forms and should not be construed as limited to the embodiments described herein. Instead, these embodiments are provided for a more thorough and complete understanding of the present disclosure. It should be understood that the accompanying drawings and embodiments of the present disclosure are for illustrative purposes only rather than limiting the protection scope of the present disclosure.

It should be understood that various steps recorded in the embodiments of the disclosed methods can be executed in different orders and/or in parallel. In addition, the method implementation can comprise additional steps and/or omit executing the shown steps. The scope of the present disclosure is not limited in this regard.

The term “comprising” and its variations used herein are nonexclusive inclusion, meaning “comprising but not limited to”. The term “based on” means “at least partially based on”. The term “one embodiment” means “at least one embodiment”; the term “another embodiment” means “at least one other embodiment”; the term “some embodiments” means “at least some embodiments”. The relevant definitions of other terms will be provided in the following description.

It should be noted that the concepts such as “first”, “second”, etc., mentioned in the present disclosure are only used to distinguish different devices, modules or units rather than to limit the order or interdependence of the functions performed by these devices, modules or units.

It should be noted that the modifications of “one” and “multiple” mentioned in the present disclosure are illustrative rather than restrictive, and those skilled in the art should understand that unless otherwise explicitly stated in the context, they should be understood as “one or more”.

Names of messages or information exchanged between multiple devices in the implementations of the present disclosure are for illustrative purposes only rather than limiting the scope of these messages or information.

The inventor found that a displaying process of a style image in related technologies is monotonous. In order to solve this technical problem, the present disclosure provides a style image generation method and apparatus, a device and a medium.

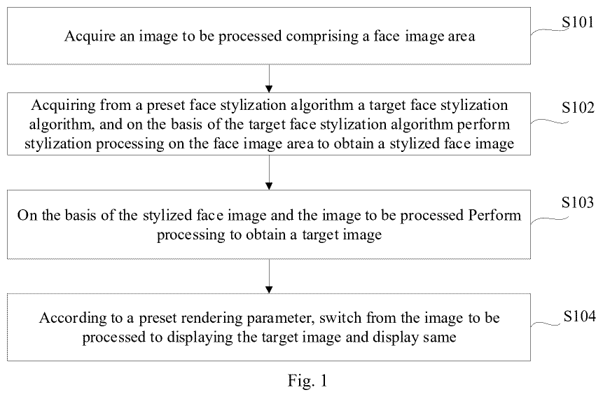

FIG. 1 is a flowchart of a style image generation method provided in some embodiments of the present disclosure. The method can be executed by a style image generation device, wherein the device can be realized using software and/or hardware and can generally be integrated into electronic device. As shown in FIG. 1, the method comprises: steps 101 to 104.

In step 101, an image to be processed comprising a face image region is acquired.

The image to be processed can be any image comprising a face image region. The face image region refers to an image region comprising a face, wherein a quantity of the face image regions can be one or more.

In some embodiment of the present disclosure, there are many ways to acquire the image to be processed comprising the face image region, which can be selected and set according to needs of application scenarios. In some embodiments, in response to a stylization processing request, a display interface is opened, an original image input is received on the display interface, and the original image is displayed after a resolution adjustment, a screenshot processing is performed on a displayed image to obtain the image to be processed. In other embodiments, in response to a stylization processing request, a target camera is turned on; based on a confirmation instruction, a captured image is acquired through the target camera and the captured image is displayed, a screenshot processing is performed on a displayed image to obtain the image to be processed. The above two ways are only examples of acquiring the image to be processed comprising the face image region, and the embodiments of the present disclosure do not limit the specific ways of acquiring the image to be processed comprising the face image region.

Specifically, after opening the display interface in response to the stylization processing request, a triggering operation of a user on the display interface can be detected. In response to an operation of the user, such as a click, etc., on a related control for inputting the original image being detected, the original image can be displayed after the resolution adjustment, and a screenshot processing is performed on a displayed image to obtain the image to be processed. In response to a stylization processing request, a target camera is turned on. In response to an operation of the user, such as touching a screen or pressing a volume key, etc., is detected, the captured image can be acquired through the target camera and displayed, a screenshot processing is performed on a displayed image to obtain the image to be processed. Therefrom, the image to be processed is acquired by supporting interactive ways such as touch screen freeze-frame and uploading image, etc., thereby further improving diversity of style image generation.

In step 102, a target face stylization algorithm is acquired from preset face stylization algorithms, and a stylization processing is performed on the face image region based on the target face stylization algorithm to obtain a face stylization image.

The face stylization algorithm refers to an algorithm used for performing a style transfer on the face image region to different styles such as big eyes, grin and small nose, etc. The preset face stylization algorithms can be understood as multiple face stylization algorithms pre-stored in a terminal, which can be selected and set according to the needs of application scenarios. For example, in a process of generating a style image based on history, an analysis is performed based on stored style images, and a style preference feature of the terminal is acquired, thereby updating the preset face stylization algorithms to further meet personalized needs.

In some embodiment of the present disclosure, after acquiring the image to be processed, there are many ways to acquire the target face stylization algorithm from the preset face stylization algorithms. In some embodiments, the target face stylization algorithm is acquired from the preset face stylization algorithms based on a preset selection rule. The preset rule is, for example, a rule of a random selection, a rule of a selection according to sorting of face stylization algorithms, or a rule of a selection according to terminal usage time, etc. That is, the target face stylization algorithm is uncertain and has certain randomness, thereby being capable of displaying a face stylization effect randomly and supporting multiple faces to further improving interest of the face stylization images.

In some embodiments of the present disclosure, there are many ways to perform the stylization processing on the face image region based on the target face stylization algorithm to obtain the face stylization image, which can be selected and set according to needs of application scenarios. In some embodiments, at least one target feature region is determined based on the face image region, at least one style material corresponding to the at least one target feature region is acquired, a processing is performed on the at least one target feature region based on the at least one style material to obtain the face stylization image(s). In some other embodiments, the face image region is input into a pre-trained style image generation model to obtain the face stylization image. The above two ways are only examples of performing the stylization processing on the face image region based on the target face stylization algorithm to obtain the face stylization image, and the embodiments of the present disclosure do not limit the specific ways of performing the stylization processing on the face image region based on the target face stylization algorithm to obtain the face stylization image.

In the embodiments of the present disclosure, after receiving the image to be processed comprising the face image region, the target face stylization algorithm is acquired randomly from the preset face stylization algorithms to perform the stylization processing on the face image region in order to obtain the face stylization image. A number of the face image region is one or more, and a number of the face stylization image can also be one or more. If the number of the face image regions is multiple, a number of the target face stylization algorithm can also be multiple, so that the face stylization images generated in different face image regions have different style effects, thereby further increasing diversity and interest of the face stylization image display.

In step 103, a processing is performed based on the face stylization image and the image to be processed to obtain a target image.

Specifically, after acquiring the face stylization image, a processing can be performed based on the face stylization image and the image to be processed to obtain the target image. In some embodiments, a target region image in the image to be processed is determined, the target region image is replaced by the face stylization image to obtain the target image. In a case where there is only one face image region, a number of the face stylization image can be more than one, consequently a number of the target region image can be more than one. For example, a stylization processing can be performed on mouth, eyes and nose at a same time to obtain three face stylization images, so that three target regions in the image to be processed are determined to be replaced to obtain the target image.

In step 104, the image to be processed is switching to displaying the target image according to a preset rendering parameter.

The rendering parameter can be selected and set according to application needs. In some embodiments, a grey processing is performed on the target image based on the rendering parameter to obtain a grey image, and an image exposure region of the grey image and an exposure speed of the image exposure region are determined, the image to be processed is switched to displaying the target image according to the exposure speed of the image exposure region. In other embodiments, a rendered image is determined based on the rendering parameter, the image to be processed is switched to displaying the rendered image and then to displaying the target image. The above two ways are only examples of switching from displaying the image to be processed to displaying the target image according to preset rendering parameter, and the embodiments of the present disclosure do not limit the specific ways of switching from displaying the image to be processed to displaying the target image according to preset rendering parameters. Therefrom, through merging different rendering effects into a displaying process, flexibility of switching from the image to be processed to the target image after stylization is increased and user experience is further improved.

In the style image generation method provided in the present embodiments of the disclosure, the image to be processed comprising the face image region is acquired, the target face stylization algorithm from preset face stylization algorithms is acquired, and the stylization processing is performed on the face image region based on the target face stylization algorithm to obtain the face stylization image, the processing is performed based on the face stylization image and the image to be processed to obtain the target image, and the image to be processed is switched to displaying the target image according to preset rendering parameter. Using the above technical solution, a rendering effect can be merged into a displaying process of generating a face stylization effect, to increase smoothness of a transition in vision and improve image display effect in a scenario of image stylization.

In some embodiments, the acquiring the image to be processed comprising the face image region, comprises: in response to a stylization processing request, opening a display interface; receiving an original image input on the display interface, and displaying the original image after a resolution adjustment; and performing a screenshot processing on a displayed image to obtain the image to be processed.

There are many ways to acquire the stylization processing request. For example, to acquire the stylization processing request in response to a clicking or a pausing on an icon of an image processing software. After acquiring the stylization processing request, the display interface is opened, the original image is received by means of an operation on a control on the display interface, and is further displayed after the resolution adjustment, and the screenshot processing is performed on the displayed image to obtain the image to be processed.

Specifically, in the embodiments of the present disclosure, the original image received may not be fit for the screen in size, etc. In order to prevent visual discomfort caused by image tension, after acquiring the original image, the original image is displayed after the resolution adjustment, thereby further meeting usage needs of a user, and improving usage experiences of the user.

Specifically, in order to avoid a performance waste caused by that different branches execute different stylization algorithms in a case where multiple photos are uploaded or acquired in other ways, in the embodiments of the present disclosure the image to be processed is obtained by performing the screenshot processing on the displayed image. That is to say, the stylization processing is performed on only one image in a whole process of generating a style image, and thus a screen frame obtained by grabbing screen again uniformly is used as the image to be processed, thereby avoiding the case where different branches execute different stylization algorithms, preventing the performance waste, and further improving efficiency of style image generation.

In some embodiments, the acquiring the image to be processed comprising the face image region comprises: in response to a stylization processing request, turning on a target camera; based on a confirmation instruction, acquiring a captured image through the target camera and displaying the captured image; and performing a screenshot processing on a displayed image to obtain the image to be processed.

There are many ways to acquire a stylization processing request. For example, to acquire the stylization processing request in response to a clicking or a pausing on an icon of an image processing software. After acquiring the stylization processing request, the target camera (either a front camera or a rear camera of equipment) is turned on, upon receiving the confirmation instruction, the captured image is acquired through the target camera and displayed, and the screenshot processing is performed on the displayed image to obtain the image to be processed.

There are many ways to acquire the confirmation instruction, which can be selected and set according to application scenarios. An operation, such as touching the screen, pressing a volume key and/or home key, etc., triggers the confirmation instruction. Therefore, a flexibility of interaction can be further increased and diversity and interest of the image stylization processing are satisfied.

In the embodiments of the present disclosure, the image to be processed is obtained by performing the screenshot processing on the displayed image. That is to say, the stylization processing is performed on only one image in a whole process of generating a style image, and thus a screen frame obtained by grabbing screen again uniformly is used as the image to be processed, thereby avoiding the case where different branches execute different stylization algorithms, preventing a performance waste and further improving efficiency of style image generation.

In some embodiments, the acquiring the target face stylization algorithm from the preset face stylization algorithms, comprises: acquiring the target face stylization algorithm from the preset face stylization algorithms based on a preset selection rule.

In the embodiments of the present disclosure, rules for selecting the face stylization algorithm, such as a random rule, a rule of a selection according to a sorting of face stylization algorithms and a rule of a selection according to terminal usage time, and other selection rules with uncertainty in specific, can be set in advance. Therefore, different face stylization effects can be generated randomly, and a randomness on different face effects can be realized in the screen in a case of multiple faces.

In some embodiments, the performing the stylization processing on the face image region based on the target face stylization algorithm to obtain the face stylization image, comprises: determining a target feature region based on the face image region; acquiring a style material corresponding to the target feature region; and performing a processing on the target feature region based on the style material to obtain the face stylization image.

The target feature region can be one or more. For example, regions such as mouth, eyes, nose, etc., are taken as the target feature regions. After determining the target feature region(s), the style material(s) corresponding to the target feature region(s) is acquired. For example, for a mouth region, a style material corresponding to the mouth region, such as a grin, a duck face, etc., is acquired. That is, different target feature regions correspond to different style materials. Thereby a diversity of an image stylization is further improved. Further, a processing, such as a rigid transformation, etc., is performed on the target feature region based on the style material to obtain the face stylization image.

In the above scheme, the stylization processing can be performed on different target feature regions extracted from the face region to further enhance a diversity of style images, meet needs of a user, improve a usage experience of the user, and further increase a retention of the user.

In some embodiments, the performing the processing on the face stylization image and the image to be processed to obtain the target image comprises: acquiring position information and a mask corresponding to the face stylization image; determining a target region image in the image to be processed based on the position information and the mask; and replacing the target region image with the face stylization image to obtain the target image.

The position information refers to position coordinates of the face stylization image in the image to be processed, and a position of the face stylization image in the image to be processed can be determined based on the position information. The mask refers to a region corresponding to the face stylization image, it can also be called a cover corresponding to the face stylization image. The target region image in the image to be processed can be determined precisely based on the position information and the mask, so that the target region image is replaced by the face stylization image to obtain the target image.

Therefrom, the face stylization image and the image to be processed can be merged precisely to obtain the target image, thereby ensuring a precise display of a style image, and meeting a visual experience of a user.

In some embodiments, the switching from displaying the image to be processed to displaying the target image according to preset rendering parameter comprises: performing a grey processing on the target image based on the rendering parameter to obtain a grey image, and determining an image exposure region of the grey image and an exposure speed of the image exposure region; and switching from displaying the image to be processed to displaying the target image according to the exposure speed of the image exposure region.

The grey processing performed on the target image is determined based on the rendering parameter to obtain the grey image, and each image exposure region of the grey image and the exposure speed corresponding to the each image exposure region are determined based a threshold of the rendering parameter. Thereby the image to be processed is switched to displaying the target image according to the exposure speed of the each image exposure region.

Therefrom, exposure content is merged into a process of switching display, and content to be exposed is displayed in a process of switching display, thereby realizing a rendering effect merged into a displaying process, and improving a flexibility of screen switching.

In some embodiments, the switching from displaying the image to be processed to displaying the target image according to preset rendering parameter comprises: determining a rendered image based on the rendering parameter; and switching from displaying the image to be processed to displaying the rendered image, and then to displaying the target image.

Wherein, the rendered image can be selected according to needs of application scenarios, the image to be processed is switched to displaying the rendered image, and then to displaying the target image.

Therefrom, displaying the rendered image in a process of switching display is realized, and merging a rendering effect into a displaying process to improve flexibility of screen switching is realized.

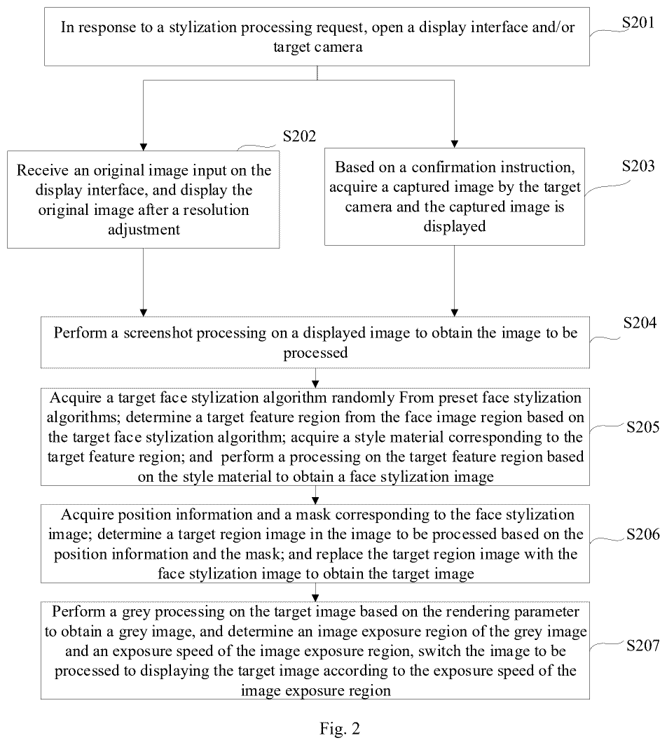

FIG. 2 is a flowchart of a style image generation method provided in some embodiments of the present disclosure. Based on the above embodiments, the present embodiments further optimizes the above style image generation method. As shown in FIG. 2, the method comprises: steps 201-207.

In step 201, in response to a stylization processing request, a display interface and/or target camera is opened.

After step 201, step 202 or step 203 can be executed.

In step 202, an original image input is received on the display interface, and displaying the original image after a resolution adjustment.

In step 203, based on a confirmation instruction, a captured image is acquired by the target camera and the captured image is displayed.

In step 204, a screenshot processing is performed on a displayed image to obtain the image to be processed.

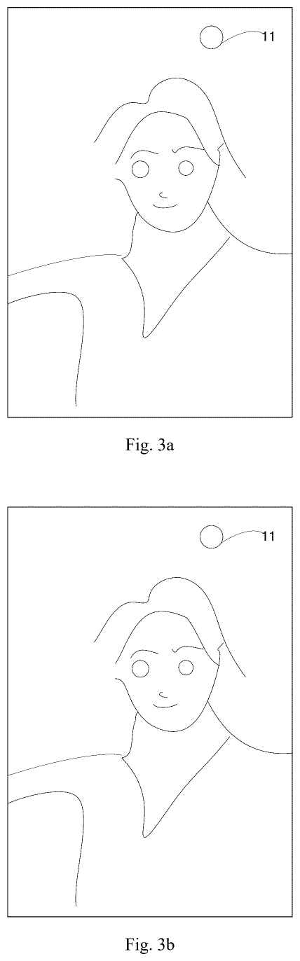

For illustration, FIG. 3a is a schematic diagram of an image display provided in some embodiments of the present disclosure, in which a schematic diagram of a display interface is shown. The display interface comprises a captured screen and a preset control 11. The control 11 is configured in a circle form. If a user triggers the control 11, the terminal can receive an operation of uploading the original image to acquire and display the original image. As shown in FIG. 3b, the uploaded original image is displayed on the display interface.

On the display interface shown in FIG. 3a, by triggering the screen or pressing a relative button, a freeze-frame processing can be done on the captured image. Therefrom, a screenshot processing is performed on the image shown in FIG. 3a or FIG. 3b to obtain the image to be processed.

Specifically, if a user does not upload the original image, an image stored at a moment of freeze-frame when grabbing the whole screen is used as the image to be processed, and then the image to be processed is used as an input for a stylization algorithm processing and a rendering effect that may be subsequently applied respectively to ensure appearing a screen undergoing a stylization processing after rendering.

Specifically, face stylization algorithms are mostly based on some deep learning models trained in advance. Computations of the models are relatively large. If each frame is computed, a stuck will happen during a process of experience. Therefore, the present embodiment of the disclosure carries out a single-frame separation in the face stylization algorithm operation to ensure that the face stylization algorithm only computes and stores one frame of image, namely, the image to be processed, and later only the stored style image is displayed when displaying, thereby improving efficiency of style image processing.

In step 205, a target face stylization algorithm is acquired randomly from preset face stylization algorithms; a target feature region is determined from the face image region based on the target face stylization algorithm; a style material corresponding to the target feature region is acquired; and a processing is performed on the target feature region based on the style material to obtain a face stylization image.

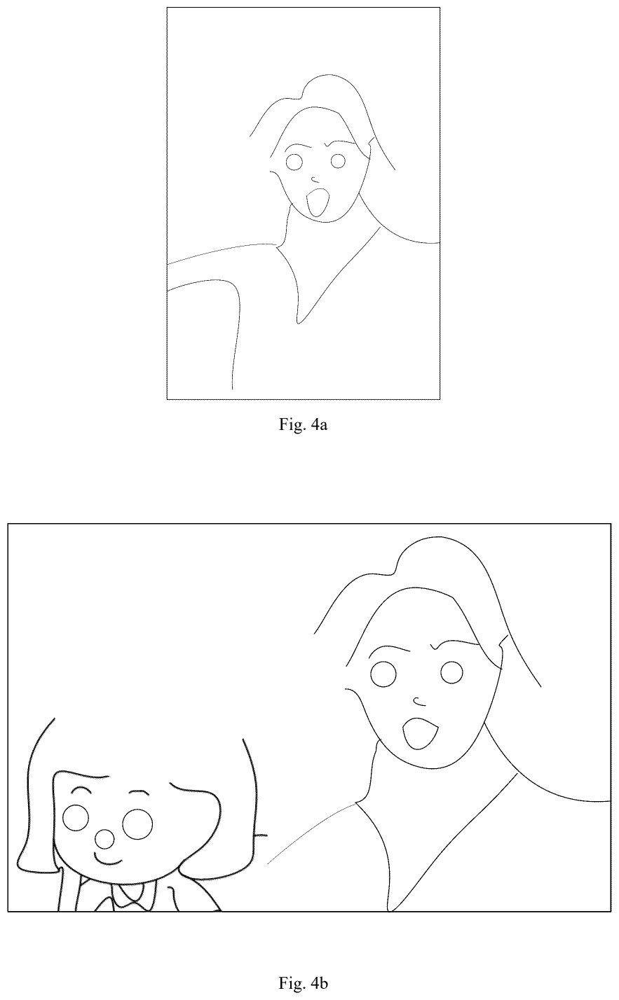

For illustration, continuously taking FIG. 3a as an example, FIG. 4a is a schematic diagram of a style image provided in some embodiments of the present disclosure. FIG. 4a shows a schematic diagram of a style image, and FIG. 3a comprises a face image region; a stylization processing is performed on the face image region to obtain a face stylization image as shown in FIG. 4a. The stylization processing is performed on a mouth in the face image region. Continuously taking FIG. 3b as an example, FIG. 4b is a schematic diagram of another style image provided in some embodiments of the present disclosure, in which a schematic diagram of a style image is shown. In the style image, different stylization processing is performed respectively on two face image regions to obtain the face stylization image as shown in FIG. 4b, in which the stylization processing is performed on a mouth in one face image region, and on hair in the other face image region.

In step 206, position information and a mask corresponding to the face stylization image are acquired; a target region image in the image to be processed is determined based on the position information and the mask; and the target region image is replaced with the face stylization image to obtain the target image.

In step 207, a grey processing is performed on the target image based on the rendering parameter to obtain a grey image, and an image exposure region of the grey image and an exposure speed of the image exposure region are determined, the image to be processed is switched to displaying the target image according to the exposure speed of the image exposure region.

Specifically, a rendering effect in a full screen covering manner is added between a freeze-frame screen or uploaded original image and the face stylization image. A style of the effect, for example, is floodlight, fading out to a white screen, etc. Transition time of a rendering transition can be just enough for completing a stylization algorithm, and smoothness of the transition in vision can be increased.

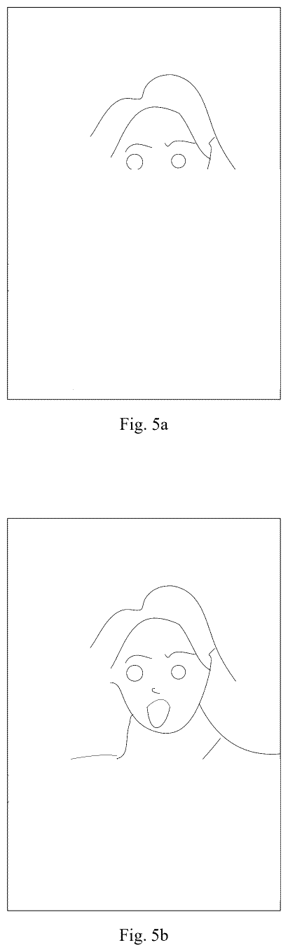

For illustration, continuously taking FIGS. 3a-4a as examples, in the process of switching from displaying the image to be processed as shown in FIG. 3a to displaying the target image as shown in FIG. 4a according to the preset rendering parameter, a part of content is exposed as shown in FIG. 5a, next another part of the content is then exposed as shown in FIG. 5b, and finally the image is displayed as shown in FIG. 4a.

Therefrom, interest of a face stylization effect is increased by means of an interactive flow, and a performance problem caused by coexistence of multiple face styles are solved by an optimizing measure. That is to say, multiple stylization face effects are built in; a switching effect is triggered by an interactive operation to transit to a random stylization face. Only one frame is computed, and its result is cached and thereafter is displayed in freeze-frame in combination with a rendering effect, thereby realizing random generations of different face stylization effects, and supporting interactive ways such as touch screen freeze-frame and uploading image, etc. In addition, merging rendering effects into the displaying process can effectively improve fluency in switching from the original image to an image after stylization, and the method of grabbing one frame as the image to be processed can effectively solve the performance problem arising when multiple face style effects run simultaneously.

In summary, in the style image generation scheme provided in the embodiments of the present disclosure, in response to the stylization processing request, the display interface and/or the target camera is opened, the original image input is received on the display interface, and the original image is displayed after the resolution adjustment, or based on the confirmation instruction, the captured image is acquired by the target camera and the captured image is displayed, the screenshot processing is performed on the displayed image to obtain the image to be processed; the target face stylization algorithm is acquired randomly from preset face stylization algorithms, the target feature region is determined from the face image region based on the target face stylization algorithm, the style material corresponding to the target feature region is acquired, the target feature region is processed based on the style material to obtain the face stylization image; the position information and the mask corresponding to the face stylization image are acquired, the target region image is determined in the image to be processed based on the position information and the mask, the target region image is replaced with the face stylization image to obtain the target image; the grey processing performed on the target image based on the rendering parameter to obtain the grey image, the image exposure region of the grey image and the exposure speed of the image exposure region are determined, and the image to be processed is switched to displaying the target image according to the exposure speed of the image exposure region. Therefrom, a face stylization effect is randomly displayed and multiple faces are supported, a preset stylization effect is assigned to each face randomly, and a randomness of different face effects on the screen is ensured. In addition, a rendering effect in a full screen covering manner is added between the original image and the face stylization image, thereby increasing a smoothness of a transition in vision and improving user retention.

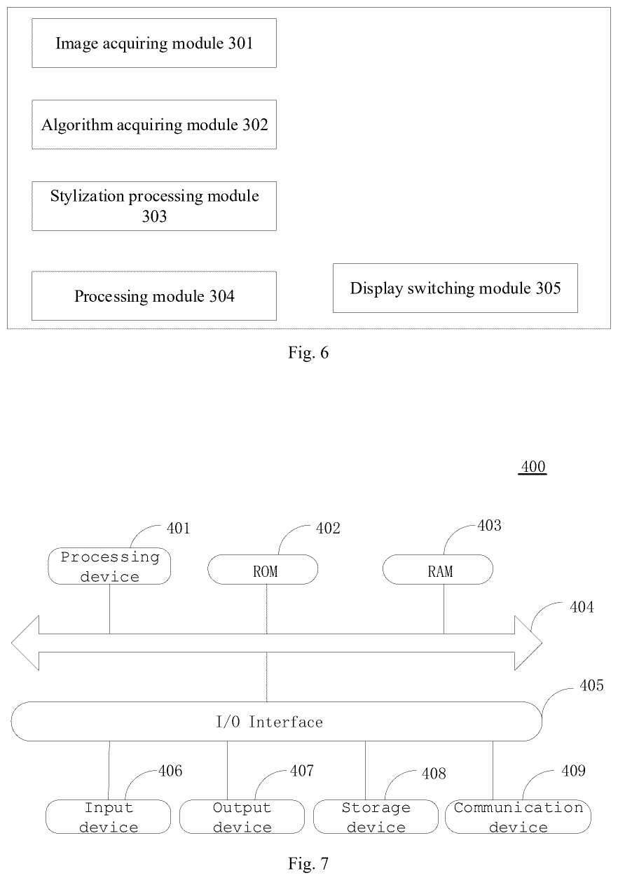

FIG. 6 is a schematic diagram of structure of a style image generation apparatus provided in some embodiments of the present disclosure, wherein the style image generation apparatus can be realized using software and/or hardware and can generally be integrated into an electronic device. As shown in FIG. 6, the style image generation apparatus comprises: an image acquiring module 301, an algorithm acquiring module 302, a stylization processing module 303, a processing module 304, a display switching module 305.

The image acquiring module 301 is configured to acquire an image to be processed comprising a face image region.

The algorithm acquiring module 302 is configured to acquire a target face stylization algorithm from preset face stylization algorithms.

The stylization processing module 303 is configured to perform a stylization processing on the face image region based on the target face stylization algorithm to obtain a face stylization image.

The processing module 304 is configured to perform a processing based on the face stylization image and the image to be processed to obtain a target image.

The display switching module 305 is configured to switch from displaying the image to be processed to displaying the target image according to preset rendering parameter.

In some embodiments, the display switching module 305 is in particular configured to:
perform a grey processing on the target image based on the rendering parameter to obtain a grey image, and determine an image exposure region of the grey image and an exposure speed of the image exposure region; and
switch from displaying the image to be processed to displaying the target image according to the exposure speed of the image exposure region.

In some embodiments, the display switching module 305 is in particular configured to:
determine a rendered image based on the rendering parameter; and
display the target image after switching from displaying the image to be processed to displaying the rendered image

In some embodiments, the algorithm acquiring module 302 is in particular configured to:
acquire the target face stylization algorithm from the preset face stylization algorithms based on a preset selection rule.

In some embodiments, the image acquiring module 301 is in particular configured to:
in response to a stylization processing request, open a display interface;
receive an original image input on the display interface, and display the original image after resolution adjustment; and
perform a screenshot processing on a displayed image to obtain the image to be processed.

In some embodiments, the image acquiring module 301 is in particular configured to:
in response to a stylization processing request, turn on a target camera;
based on a confirmation instruction, acquire a captured image through the target camera and display captured image; and
perform a screenshot processing on a displayed image to obtain the image to be processed.

In some embodiments, the stylization processing module 303 is in particular configured to:
determine at least one target feature region based on the face image region;
acquire at least one style material corresponding to the at least one target feature region; and
process the at least one target feature region based on the at least one style material to obtain the face stylization image.

In some embodiments, the processing module 304 is in particular configured to:
acquire position information and a mask corresponding to the face stylization image;
determine a target region image in the image to be processed based on the position information and the mask; and
replace the target region image with the face stylization image to obtain the target image.

The style image generation apparatus provided in the embodiments of the present disclosure can execute the style image generation method provided in any embodiment of the present disclosure, and has corresponding functional modules and beneficial effects for executing the method.

The embodiments of the present disclosure also provide a computer program product, comprising a computer program/instruction, which when executed by a processor, causes the processor to implement the style image generation method provided in any embodiment of the present disclosure.

FIG. 7 is a schematic diagram of structure of an electronic device provided in some embodiments of the present disclosure. Referring to FIG. 7 in particular, it illustrates a schematic diagram of the structure that is suitable for realizing the electronic device 400 in the present embodiment of the disclosure. The electronic device 400 in the present embodiment of the disclosure can comprise, but not limited to, a mobile terminal such as a mobile phone, a laptop computer, a digital broadcasting receiver, a PDA (Personal Digital Assistant), a PAD (tablet computer), a PMP (Portable Multimedia Player), a vehicle-mounted terminal (e.g. a vehicle-mounted navigation terminal), etc., and a fixed terminal such as a digital TV, a desktop computer, etc. The electronic device shown in FIG. 7 is only an example and should not impose any limitations on the functions and usage scope of the embodiments of the present disclosure.

As shown in FIG. 7, the electronic device 400 can comprise a processing device (e.g. a central processing unit, a graphics processor, etc.) 401, which can perform various appropriate actions and processes according to programs stored in a Read-Only Memory (ROM) 402 or programs loaded from a storage device 408 into a Random Access Memory (RAM) 403. In the RAM 403 are also stored various programs and data required for operations of the electronic device 400. The processing device 401, ROM 402, and RAM 403 are connected to each other through a bus 404. An input/output (I/O) interface 405 is also connected to the bus 404.

Typically, the following devices can be connected to the I/O interface 405: an input device 406 comprising: for example, a touch screen, a touchpad, a keyboard, a mouse, a camera, a microphone, an accelerometer, a gyroscope, etc.; an output device 407 comprising: for example, a liquid crystal display (LCD), a speaker, a vibrator, etc.; a storage device 408 comprising: for example, a magnetic tape, a hard disk, etc.; and a communication device 409. The communication device 409 can allow the electronic device 400 to communicate wirelessly or wired with other devices to exchange data. Although FIG. 7 illustrates the electronic device 400 with various devices, it should be understood that it is not required to implement or have all the shown devices. More or fewer devices can be implemented or included as an alternative.

Specifically, according to the embodiments of the present disclosure, the process described above with reference to the flowchart can be realized as a computer software program. For example, some embodiments of the present disclosure comprise a computer program product, which comprises a computer program carried on a non-transient computer-readable medium, wherein the computer program comprises program codes for executing the method shown in the flowchart. In such embodiments, the computer program can be downloaded and installed from network through the communication device 409, or installed from the storage device 408, or installed from the ROM 402. When the computer program is executed by the processing device 401, the above functions defined in the style image generation method of the embodiment of the present disclosure are performed.

It should be noted that the above computer-readable medium mentioned in the present disclosure can be a computer-readable signal medium, a computer-readable storage medium, or any combination of both. The computer-readable storage medium, for example, can be, but not limited to, an electrical, magnetic, optical, electromagnetic, infrared, or semiconductor system, device, or component, or any combination thereof. More specific examples of the computer-readable storage medium may comprise, but not limited to: an electrical connection with one or more wires, a portable computer disk, a hard disk, a Random Access Memory (RAM), a Read-Only Memory (ROM), an Erasable Programmable Read-Only Memory (EPROM or flash), a fiber optic, a Portable Compact Disk Read-Only Memory (CD-ROM), an optical storage device, a magnetic storage device, or any suitable combination thereof. In the present disclosure, the computer-readable storage medium can be any tangible medium containing or storing a program, which can be used by an instruction execution system, device, or component, or in combination with the same. While in the present disclosure, the computer-readable signal medium can comprise data signals propagated in the baseband or as a part of the carrier wave, which carry computer-readable program codes. This type of propagated data signals can take various forms, comprising but not limited to electromagnetic signal, optical signal, or any suitable combination thereof. The computer-readable signal medium can also be any computer-readable medium other than the computer-readable storage medium, which can send, propagate, or transmit a program used by or in combination with the instruction execution system, device, or component. The program codes contained in the computer-readable medium can be transmitted using any appropriate medium, comprising but not limited to: wire, optical cable, RF (Radio Frequency), etc., or any suitable combination thereof.

In some implementations, a client and a server can communicate using any currently known or future developed network protocol, such as HTTP (HyperText Transfer Protocol), and can interconnect with any form or medium of digital data communication (such as communication network). Examples of the communication network comprise Local Region Network (“LAN”), Wide Region Network (“WAN”), internet (for example, the Internet), and end-to-end network (for example, ad hoc end-to-end network), as well as any currently known or future developed network.

The computer-readable medium mentioned above can be included in the aforesaid electronic device; it can also exist separately without being assembled into the electronic device.

The computer-readable medium mentioned above carries one or more programs, which when executed by the electronic device, enable the electronic device to: in a process of playing a video, receive an information display triggering operation of a user; acquire at least two target information entries associated with the video; display a first target information entry of the at least two target information entries in an information display region of a playing page of the video, wherein the information display region is smaller than the playing page in size; receive a first switching triggering operation of the user to switch from the first target information entry displayed in the information display region to a second target information entry of the at least two information entries.

The computer program codes for executing operations of the present disclosure may be written in one or more programming languages or combinations thereof, comprising, but not limited to, object-oriented programming languages such as Java, Smalltalk, C++, and conventional procedural programming languages such as C or similar programming languages. The program codes can be completely executed on a user's computer, partially executed on a user's computer, executed as an independent software package, partially executed on a user's computer and partially executed on a remote computer, or completely executed on a remote computer or server. In the case involving a remote computer, the remote computer can connect to the user's computer through any type of network (comprising Local Region Network (LAN) or Wide Region Network (WAN)), or can connect to an external computer (e.g. connect via the Internet using an Internet service provider).

The flowchart and block diagram in the accompanying drawings illustrate the possible architecture, functions, and operations of the system, method, and computer program product according to various embodiments of the present disclosure. At this point, each box in the flowchart or block diagram can represent a module, program segment, or part of codes that includes one or more executable instructions for realizing a specified logical function. It should also be noted that in some alternative implementations, the functions indicated in the box can also occur in a different order than those indicated in the accompanying drawings. For example, two consecutive boxes can actually be executed in basically parallel, and sometimes they can also be executed in reverse order, depending on the function involved. It should also be noted that each box in the block diagram and/or flowchart, as well as the combination of boxes in the block diagram and/or flowchart, can be realized using a dedicated hardware based system that executes specified functions or operations, or can be realized using a combination of dedicated hardware and computer instructions.

The involved units described in the embodiments of the present disclosure can be realized in form of software or in form of hardware. Names of the units do not constitute a limitation on the units in a certain situation.

The above functions described herein can be at least partially executed by one or more hardware logic components. For example, non-restrictively, demonstration types of the hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), and the like.

In the context of the present disclosure, a machine readable medium can be a tangible medium that can comprise or store a program that can be used by an instruction execution system, device, or equipment or in combination with an instruction execution system, device, or equipment. The machine readable medium can be a machine readable signal medium or a machine readable storage medium. The machine readable medium can comprise but not limited to an electronic, magnetic, optical, electromagnetic, infrared, or semiconductor system, device, or equipment, or any suitable combination thereof. More specific examples of the machine readable storage medium can comprise electrical connection based on one or more wires, portable computer disk, hard disk, Random Access Memory (RAM), Read-Only Memory (ROM), Erasable Programmable Read-Only Memory (EPROM or flash memory), optical fiber, Compact Disc Read-Only Memory (CD-ROM), optical storage device, magnetic storage device, or any suitable combination thereof.

According to some embodiments of the present disclosure, the present disclosure provides a style image generation method, comprising:
acquiring an image to be processed comprising a face image region;
randomly acquiring a target face stylization algorithm from preset face stylization algorithms, and performing a stylization processing on the face image region based on the target face stylization algorithm to obtain a face stylization image;
performing a processing based on the face stylization image and the image to be processed to obtain a target image; and
switching from displaying the image to be processed to displaying the target image according to a preset rendering parameter.

According to some embodiments of that present disclosure, in the style image generation method provided in the present disclosure, the switching from displaying the image to be processed to displaying the target image according to a preset rendering parameter comprises:
performing a grey processing on the target image based on the rendering parameter to obtain a grey image, and determining an image exposure region of the grey image and an exposure speed of the image exposure region; and
switching from displaying the image to be processed to displaying the target image according to the exposure speed of the image exposure region.

According to some embodiments of that present disclosure, in the style image generation method provided in the present disclosure, the switching from displaying the image to be processed to displaying the target image according to a preset rendering parameter comprises:
determining a rendered image based on the rendering parameter; and
switching from displaying the image to be processed to displaying the rendered image and then to displaying the target image.

According to some embodiments of that present disclosure, in the style image generation method provided in the present disclosure, the acquiring an image to be processed comprising a face image region comprises:
acquiring the target face stylization algorithm from the preset face stylization algorithms based on a preset selection rule.

According to some embodiments of that present disclosure, in the style image generation method provided in the present disclosure, the acquiring an image to be processed comprising a face image region comprises:
in response to a stylization processing request, opening a display interface;
receiving an original image input on the display interface, and displaying the original image after a resolution adjustment; and
performing a screenshot processing on a displayed image to obtain the image to be processed.

According to some embodiments of that present disclosure, in the style image generation method provided in the present disclosure, the acquiring an image to be processed comprising a face image region comprises:
in response to a stylization processing request, turning on a target camera;
based on a confirmation instruction, acquiring a captured image through the target camera and displaying the captured image; and
performing a screenshot processing on a displayed image to obtain the image to be processed.

According to some embodiments of that present disclosure, in the style image generation method provided in the present disclosure, the performing a stylization processing on the face image region based on the target face stylization algorithm to obtain a face stylization image comprises:
determining at least one target feature region based on the face image region;
acquiring at least one style material corresponding to the at least one target feature region; and
processing the at least one target feature region based on the at least one style material to obtain the face stylization image.

According to some embodiments of that present disclosure, in the style image generation method provided in the present disclosure, the performing a processing based on the face stylization image and the image to be processed to obtain a target image comprises:
acquiring position information and a mask corresponding to the face stylization image;
determining a target region image in the image to be processed based on the position information and the mask; and
replacing the target region image with the face stylization image to obtain the target image.

According to some embodiments of that present disclosure, the present disclosure provides a style image generation apparatus, comprising:
an image acquiring module configured to acquire an image to be processed comprising a face image region;
an algorithm acquiring module configured to randomly acquire a target face stylization algorithm from preset face stylization algorithms;
a stylization processing module configured to perform a stylization processing on the face image region based on the target face stylization algorithm to obtain a face stylization image;
a processing module configured to perform a processing based on the face stylization image and the image to be processed to obtain a target image; and
a display switching module configured to switch from displaying the image to be processed to displaying the target image according to a preset rendering parameter.

According to some embodiments of that present disclosure, in the style image generation device provided in the present disclosure, the display switching module is in particular configured to:
perform a grey processing on the target image based on the rendering parameter to obtain a grey image, and determine an image exposure region of the grey image and an exposure speed of the image exposure region; and
switch from displaying the image to be processed to displaying the target image according to the exposure speed of the image exposure region.

According to some embodiments of that present disclosure, in the style image generation device provided in the present disclosure, the display switching module is in particular configured to:
determine a rendered image based on the rendering parameter; and
display the target image after switching from displaying the image to be processed to displaying the rendered image.

According to some embodiments of that present disclosure, in the style image generation device provided in the present disclosure, the algorithm acquiring module is in particular configured to:
acquire the target face stylization algorithm from the preset face stylization algorithms based on a preset selection rule.

According to some embodiments of that present disclosure, in the style image generation device provided in the present disclosure, the image acquiring module is in particular configured to:
in response to a stylization processing request, open a display interface;
receive an original image input on the display interface and display the original image after a resolution adjustment; and
perform a screenshot processing on a displayed image to obtain the image to be processed.

According to some embodiments of that present disclosure, in the style image generation device provided in the present disclosure, the image acquiring module is in particular configured to:
in response to a stylization processing request, turn on a target camera based on a confirmation instruction;
based on a confirmation instruction, acquire a captured image through the target camera and display the captured image; and
perform a screenshot processing on a displayed image to obtain the image to be processed.

According to some embodiments of that present disclosure, in the style image generation device provided in the present disclosure, the stylization processing module is in particular configured to:
determine at least one target feature region based on the face image region;
acquire at least one style material corresponding to the at least one target feature region; and
process the at least one target feature region based on the style material to obtain the face stylization image.

According to some embodiments of that present disclosure, in the style image generation device provided in the present disclosure, the processing module is in particular configured to:
acquire position information and a mask corresponding to the face stylization image;
determine a target region image in the image to be processed based on the position information and the mask; and
replace the target region image with the face stylization image to obtain the target image.

According to some embodiments of the present disclosure, the present disclosure provides an electronic device, comprising:
a processor;
a memory configured to store executable instructions of the processor,
wherein the processor is configured to read the executable instructions from the memory and executing the executable instructions to implement the style image generation method as provided in any embodiment of the present disclosure.

According to some embodiments of the present disclosure, the present disclosure provides a computer-readable storage medium, wherein the storage medium stores a computer program, which when executed by a processor causes the processor to implement the style image generation method as provided in any embodiment of the present disclosure.

The above description is only for explaining the preferred embodiments of the present disclosure and the technical principles used. Those skilled in the art should understand that the scope of disclosure involved in the present disclosure is not limited to technical solutions formed by specific combinations of the aforementioned technical features, and should also cover other technical solutions formed by arbitrary combination of the aforementioned technical features or their equivalent features when not departing from the disclosed concept. For example, a technical solution formed by exchanging the above features with the technical features with similar functions disclosed (but not limited to) in the present disclosure.

Furthermore, although the operations are depicted in a specific order, this should not be understood as requiring them to be executed in the specific order shown or in sequential order. In certain environments, multitasking and parallel processing may be advantageous. Similarly, although several specific implementation details are included in the above discussion, these should not be construed as limitations on the scope of the present disclosure. Some features described in the context of individual embodiments can also be combined to be implemented in a single embodiment. On the contrary, various features described in the context of a single embodiment can also be implemented separately or in multiple embodiments in any suitable manner of sub-combination.

Although the subject matter has been described in language specific to structural features and/or method logical actions, it should be understood that the subject matter defined in the attached claims may not necessarily be limited to the specific features or actions described above. On the contrary, the specific features and actions described above are only exemplary forms of implementing the claims.

1. A style image generation method, comprising:
acquiring an image to be processed comprising a face image region;
acquiring a target face stylization algorithm from preset face stylization algorithms, and performing a stylization processing on the face image region based on the target face stylization algorithm to obtain a face stylization image;
performing a processing based on the face stylization image and the image to be processed to obtain a target image; and
switching from displaying the image to be processed to displaying the target image according to a preset rendering parameter.

2. The style image generation method according to claim 1, wherein the switching from displaying the image to be processed to displaying the target image according to the preset rendering parameter comprises:
performing a grey processing on the target image based on the rendering parameter to obtain a grey image, and determining an image exposure region of the grey image and an exposure speed of the image exposure region; and
switching from displaying the image to be processed to displaying the target image according to the exposure speed of the image exposure region.

3. The style image generation method according to claim 1, wherein the switching from displaying the image to be processed to displaying the target image according to the preset rendering parameter comprises:
determining a rendered image based on the rendering parameter; and
displaying the target image after switching from displaying the image to be processed to displaying the rendered image.

4. The style image generation method according to claim 1, wherein the acquiring the target face stylization algorithm from preset face stylization algorithms comprises:
acquiring the target face stylization algorithm from the preset face stylization algorithms based on a preset selection rule.

5. The style image generation method according to claim 1, wherein the acquiring the image to be processed comprising the face image region comprises:
in response to a stylization processing request, opening a display interface;
receiving an original image input on the display interface, and displaying the original image after a resolution adjustment; and
performing a screenshot processing on a displayed image to obtain the image to be processed.

6. The style image generation method according to claim 1, wherein the acquiring the image to be processed comprising the face image region comprises:
in response to a stylization processing request, turning on a target camera;
based on a confirmation instruction, acquiring a captured image through the target camera and displaying the captured image; and
performing a screenshot processing on a displayed image to obtain the image to be processed.

7. The style image generation method according to claim 1, wherein the performing the stylization processing on the face image region based on the target face stylization algorithm to obtain the face stylization image comprises:
determining at least one target feature region based on the face image region;
acquiring at least one style material corresponding to the at least one target feature region; and
processing the at least one target feature region based on the at least one style material to obtain the face stylization image.

8. The style image generation method according to claim 1, wherein the performing the processing based on the face stylization image and the image to be processed to obtain the target image comprises:
acquiring position information and a mask corresponding to the face stylization image;
determining a target region image in the image to be processed based on the position information and the mask; and
replacing the target region image with the face stylization image to obtain the target image.

9. The style image generation method according to claim 7, wherein the at least one target feature region comprises multiple target feature regions, different target feature regions correspond to different style materials, and a number of the face stylization image is multiple.

10-15. (canceled)

16. An electronic device, wherein the electronic device comprises:
a processor; and
a memory configured to store executable instructions of the processor,
wherein the processor is configured to read the executable instructions from the memory and executing the executable instructions to:
acquire an image to be processed comprising a face image region;
acquire a target face stylization algorithm from preset face stylization algorithms, and perform a stylization processing on the face image region based on the target face stylization algorithm to obtain a face stylization image;
perform a processing based on the face stylization image and the image to be processed to obtain a target image; and
switch from displaying the image to be processed to displaying the target image according to a preset rendering parameter.

17. A non-transitory computer-readable storage medium, wherein
the storage medium stores a computer program, which when executed by a processor causes the processor to:
acquire an image to be processed comprising a face image region;
acquire a target face stylization algorithm from preset face stylization algorithms, and perform a stylization processing on the face image region based on the target face stylization algorithm to obtain a face stylization image;
perform a processing based on the face stylization image and the image to be processed to obtain a target image; and
switch from displaying the image to be processed to displaying the target image according to a preset rendering parameter.

18. (canceled)

19. The electronic device according to claim 16, wherein the switching from displaying the image to be processed to displaying the target image according to the preset rendering parameter comprises:
performing a grey processing on the target image based on the rendering parameter to obtain a grey image, and determining an image exposure region of the grey image and an exposure speed of the image exposure region; and
switching from displaying the image to be processed to displaying the target image according to the exposure speed of the image exposure region.

20. The electronic device according to claim 16, wherein the switching from displaying the image to be processed to displaying the target image according to preset rendering parameter comprises:
determining a rendered image based on the rendering parameter; and
displaying the target image after switching from displaying the image to be processed to displaying the rendered image.

21. The electronic device according to claim 16, wherein the acquiring the target face stylization algorithm from preset face stylization algorithms comprises:
acquiring the target face stylization algorithm from the preset face stylization algorithms based on a preset selection rule.

22. The electronic device according to claim 16, wherein the acquiring the image to be processed comprising the face image region comprises:
in response to a stylization processing request, opening a display interface;
receiving an original image input on the display interface, and displaying the original image after a resolution adjustment; and
performing a screenshot processing on a displayed image to obtain the image to be processed.

23. The electronic device according to claim 16, wherein the acquiring the image to be processed comprising the face image region comprises:
in response to a stylization processing request, turning on a target camera;
based on a confirmation instruction, acquiring a captured image through the target camera and displaying the captured image; and
performing a screenshot processing on a displayed image to obtain the image to be processed.

24. The electronic device according to claim 16, wherein the performing the stylization processing on the face image region based on the target face stylization algorithm to obtain the face stylization image comprises:
determining at least one target feature region based on the face image region;
acquiring at least one style material corresponding to the at least one target feature region; and
processing the at least one target feature region based on the at least one style material to obtain the face stylization image.

25. The electronic device according to claim 16, wherein the performing the processing based on the face stylization image and the image to be processed to obtain the target image comprises:
acquiring position information and a mask corresponding to the face stylization image;
determining a target region image in the image to be processed based on the position information and the mask; and
replacing the target region image with the face stylization image to obtain the target image.

26. The electronic device according to claim 24, wherein in response to the at least one target feature region comprising multiple target feature regions, different target feature regions correspond to different style materials, and a number of the face stylization image is multiple.

27. The non-transitory computer-readable storage medium according to claim 17, wherein the switching from displaying the image to be processed to displaying the target image according to the preset rendering parameter comprises:
performing a grey processing on the target image based on the rendering parameter to obtain a grey image, and determining an image exposure region of the grey image and an exposure speed of the image exposure region; and
switching from displaying the image to be processed to displaying the target image according to the exposure speed of the image exposure region.
